(19) United States
(12) Patent Application Publication
(10) Pub. No.: US 2013/0265759 A1
(43) Pub. Date: Oct. 10, 2013

(54) LIGHT EMITTING MODULE

(71) Applicant: DELTA ELECTRONICS, INC., Taoyuan County (TW)

(72) Inventor: Chung-Hao CHEN, Taoyuan County (TW)

(73) Assignee: DELTA ELECTRONICS, INC., Taoyuan County (TW)

(21) Appl. No.: 13/859,379

(22) Filed: Apr. 9, 2013

(30) Foreign Application Priority Data
Apr. 9, 2012 (TW) 101112474

(51) Int. Cl. F21V 23/00; F21V 7/10

(52) U.S. Cl. CPC F21V 23/002; F21V 7/10
USPC 362/235

(57) ABSTRACT

A light emitting module includes a circuit board, a reflective layer, at least one light emitting chip and at least one metal wire. The circuit board has at least one connecting pad. The reflective layer is disposed on the circuit board and has at least one first opening exposing the connecting pad and at least one second opening exposing the circuit board. The light emitting chip is located in the second opening. The metal wire has a first end portion connecting to the connecting pad and a second end portion extending from the first end portion and crossing above the reflective layer and electrically connecting to the light emitting chip in the second opening. Consequently, the reflective layer can extend close to the light emitting chip and maximize the covered area of the reflective layer, and thus increase the light emitting efficiency of the light emitting module.

### BACKGROUND OF THE INVENTION

1. Field of invention

The invention relates to a light emitting module, and in particular to a light emitting module with light emitting chips directly disposed on a circuit board.

2. Related art

Light emitting diode (LED) has an advantage of energy conservation. LED may become a new generation of light source by replacing traditional light bulbs or fluorescent lamps for indoor and outdoor lighting application. Typically, multiple LED elements are assembled to form a light emitting module providing sufficient light intensity depended on a specific occasion because a single LED element may only provide a finite light intensity.

A conventional LED element includes a light emitting chip disposed on an insulating base; an encapsulating material for encapsulating the light emitting chip, the encapsulating material fitting to the insulating base; and a leadframe with at least one metal wire for electrically connecting with an external power source. Accordingly, the light emitting chip can emit light. A conventional LED module includes a circuit board and a plurality of assembled LED elements disposed on the circuit board, and the metal wire of each LED element electrically connect to an interconnection layer of the circuit board respectively.

FIG. 1 shows a conventional light emitting module. The light emitting chip 11 is disposed directly on a circuit board 12 to form “chip on board (COB).” The circuit board 12 includes a metal substrate 121, an insulating layer 122 disposed on the metal substrate 121 and an interconnection layer 123 disposed on the insulating layer 122. Since the LED chip 11 is in direct contact with the metal substrate 121, the heat produced by lighting the LED chip 11 can be dissipated by high thermal conductivity of the metal substrate 121. The LED chip has two electrodes with metal wires 15 bonded to the interconnection layer 123. The power source is supplied to the LED chip 11 by connecting the interconnection layer 123 with the external power source.

A reflective layer 13 is formed on the interconnection layer 123 to improve the reflection of the light emitted from the LED chip 11 away from the direction of circuit substrate. Also, an encapsulating material 14 is used to encapsulate the LED chip 11. The LED module shown in FIG. 1 obviously has advantages of the simplified structure and processes of manufacturing the LED module.

However, the metal wires 15 are required for electrically connecting the light emitting chip 11 with the interconnection layer 123. An end 124 of the interconnection layer 123 adjacent the light emitting chip 11 has to be exposed out of the reflective layer 13 for electrically connecting the end 124 with the light emitting chip 11 by the metal wire 15. Accordingly, at least one specific distance L is provided between the light emitting chip 11 and the reflective layer 13, and thus the reflective layer 13 may not further extend to an edge of the light emitting chip 11. The part of light emitted from the light emitting chip may not be reflected outwards by the reflective layer 13 and thus the light emitting efficiency of the whole light emitting module may be decreased.

### SUMMARY OF THE INVENTION

It is a primary object of the present invention to provide a light emitting module having a maximized area of a reflective layer to improve the reflectivity of light emitted from the light emitting chip.

In order to achieve the forementioned object, the present invention provides a light emitting module comprising a circuit board, a reflective layer, at least one light emitting chip and at least one metal wire. The circuit board has at least one connecting pad. The reflective layer is disposed on the circuit board, and has at least one first opening to expose the connecting pad and has at least one second opening to expose a portion of the circuit board. The light emitting chip is disposed in the second opening. The metal wire has a first end portion connecting with the connecting pad in the first opening and a second end portion extending from the first end portion and above the reflective layer, the second end portion electrically connecting with the light emitting chip in the second opening.

Moreover, the present invention provides another light emitting module comprising a circuit board, a reflective layer and at least one light emitting chip. The circuit board has at least one connecting pad. The reflective layer is disposed on the circuit board, and has at least one first opening to expose the connecting pad. The light emitting chip is disposed in the first opening, and has at least one electrode disposed on the lower surface thereof directly connecting to the connecting pad.

The reflective layer of the invention can be extended to an edge of the light emitting chip as possible so that a covering area of the reflective layer can be maximized to improve the reflectivity of light emitted from the light emitting chip and to enhance the light emitting efficiency of the whole light emitting module.

### BRIEF DESCRIPTION OF THE DRAWINGS

FIG. 1 is a schematic cross-sectional view showing a conventional light emitting module;

FIG. 2 is a schematic cross-sectional view showing a light emitting module of a first embodiment according to the present invention;

FIG. 3 is a schematic top view showing a light emitting module of the first embodiment according to the present invention;

FIG. 4 is a schematic illustration showing a light emitting module of the first embodiment according to the present invention;

FIG. 5 is a schematic cross-sectional view showing a light emitting module of a second embodiment according to the present invention;

FIG. 6A is a schematic cross-sectional view showing a light emitting module of a third embodiment according to the present invention and FIG. 6B is a variation of FIG. 6A;

FIG. 7A is a schematic cross-sectional view showing a light emitting module of a fourth embodiment according to the present invention and FIG. 7B is a variation of FIG. 7A;

FIG. 8 is a schematic cross-sectional view showing a light emitting module of a fifth embodiment according to the present invention; and

FIG. 9 is a schematic top view showing a light emitting module of the fifth embodiment according to the present invention.

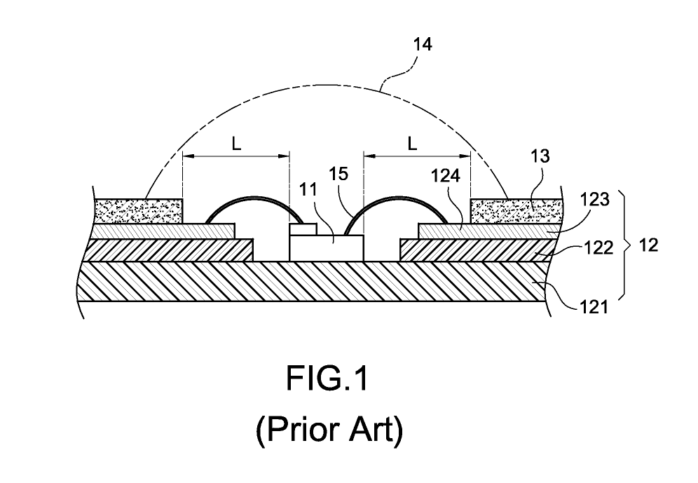

### DETAILED DESCRIPTION OF THE INVENTION

The present invention will be apparent from the following detailed description, which proceeds with reference to the accompanying drawings.

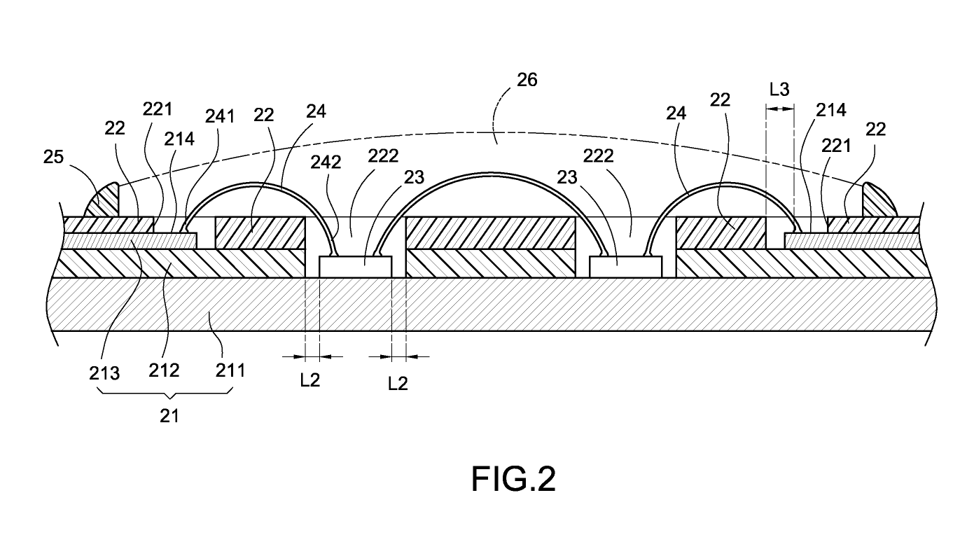

FIG. 2 is a schematic cross-sectional view showing a light emitting module of a first embodiment according to the present invention. As shown in FIG. 2, the light emitting module comprises a circuit board 21, a reflective layer 22, a plurality of light emitting chips 23 and a plurality of metal wires 24.

In the embodiment, the circuit board 21 comprises a metal substrate 211 having excellent thermal conductivity, an insulating layer 212 disposed on the metal substrate 211 and an interconnection layer 213 disposed on the insulating layer 212. The interconnection layer 213 comprises at least one connecting pad 214. The material of the metal substrate 211 can be aluminum, copper, Cu—Al alloy and the like having high thermal conductivity.

The reflective layer 22 is disposed on the circuit board 21, and has at least one first opening 221 to expose the connecting pad 214 of the interconnection layer 213. In addition, reflective layer 22 further has at least one second opening 222 to expose a portion of the circuit board 21. The reflective layer 22 can be formed with the material of white and high reflectivity, for example a mixture of silica gel and titanium dioxide particles, having reflectivity more than 60%, in particular more than 80%.

The light emitting chip 23 is disposed in the second opening 222 and is electrically connected with the metal substrate 211 of the circuit board 21. In the embodiment, the light emitting chip 23 has two electrodes formed on the upper surface. Two metal wires 24 are bonded to the upper surface of the light emitting chip 23. The light emitting chip 23 can be LED chip or laser diode chip.

The metal wire 24 is formed by wire bonding, above the reflective layer 22, and electrically connected the light emitting chip 23 and the interconnection layer 213 of the circuit board 21. Specifically, the metal wire 24 has a first end portion 241 and a second end portion 242 opposite to the first end portion 241. The first end portion 241 is connected with the connecting pad 214 in the first opening 221. The second end portion 242 is extended from the first end portion 241 and above the reflective layer 22, and electrically connected with the light emitting chip 23 in the second opening 222.

Moreover, the light emitting module further includes an annular protruded structure 25 disposed on the reflective layer 22. In the embodiment, after the reflective layer 22 is formed, the annular protruded structure 25 is formed thereon. Alternatively, the reflective layer 22 and the annular protruded structure 25 can be formed integrally by using the same material in the same step of the process. The light emitting module can further include a transparent protective layer 26 formed on the light emitting chip 23 with an edge of the annular protruded structure 25 serving as a boundary. The protective layer 26 can be material of silica gel, epoxy or a mixture of epoxy, and used for protecting the light emitting chip 23 and the metal wire 24.

Also, phosphor material can be added into the transparent protective layer 26 so that the protective layer 26 acts as a wave length conversion layer for converting the wave length of the light emitted from the light emitting chip 23. The phosphor material can be YAG phosphor, silicate phosphor, nitride phosphor, oxide phosphor and aluminum oxide phosphor.

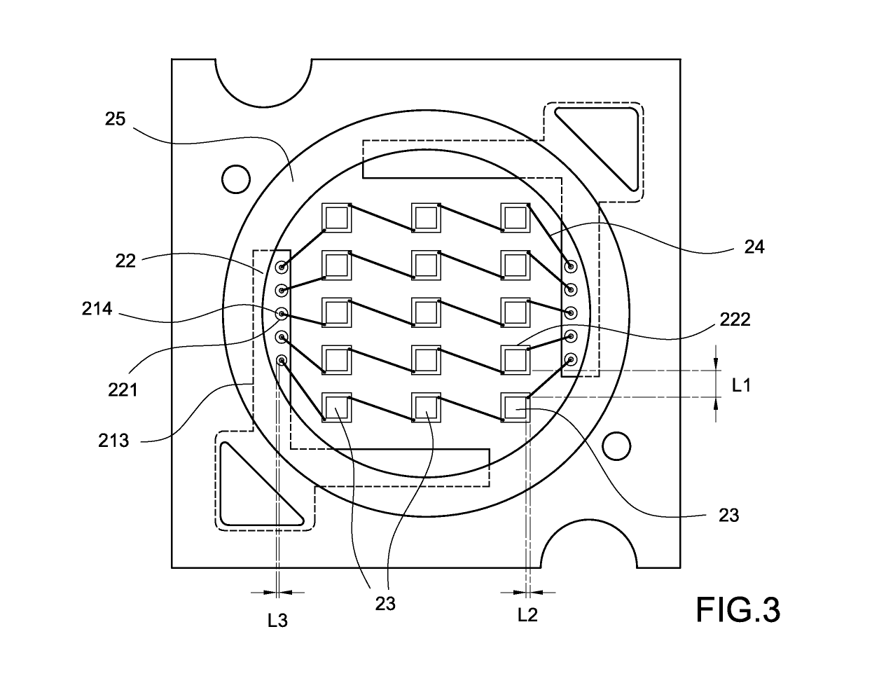

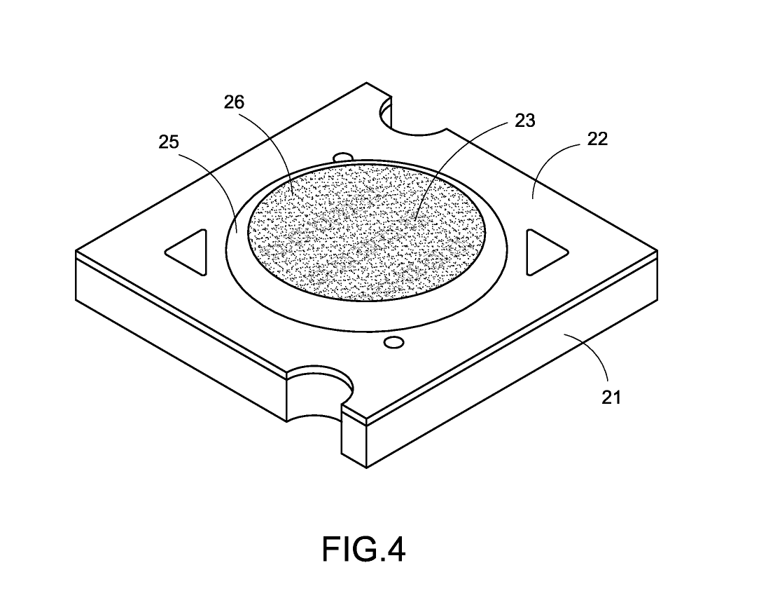

FIG. 3 is a schematic top view showing a light emitting module of the first embodiment according to the present invention. As shown in FIGS. 2 and 3, the annular protruded structure 25 is substantially a circle around all the perimeters of the first opening 221 and the second opening 222. The annular protruded structure 25 has a profile of cylinder, semi-cylinder, cylinder-like, triangle, triangle-like, trapezoid, trapezoid-like, rectangle, rectangle-like or the other shapes with a closed section.

In another word, the annular protruded structure 25 is disposed to surround all the light emitting chips 23 and the metal wires 24. In order to maximize a reflective layer covering area, the second opening 222 has a shape in accordance with a shape of the light emitting chip 23. In the embodiment, the light emitting module includes a plurality of light emitting chip 23 correspondent with a plurality of second opening 222 in number. Also, the light emitting chip 23 are arranged in an array, and every two adjacent light emitting chips 23 are separated with a first predetermined distance L1. For example, the first predetermined distance L1 is greater than or equal to 0.5 mm, preferred greater than or equal to 0.6 mm. In addition, the reflective layer 22 and each of the light emitting chips 23 separated with a second predetermined distance L2. For example, the second predetermined distance L2 is less than or equal to 0.5 mm, preferred less than or equal to 0.1 mm. The reflective layer 22 and the first end portion 241 of the metal wire 24 connecting to the connecting pad 214 are separated with a third predetermined distance L3. For example, the third predetermined distance L3 is less than or equal to 0.5 mm, preferred less than or equal to 0.1 mm. FIG. 4 is a schematic illustration showing a light emitting module of the first embodiment according to the present invention.

Accordingly, since the metal wire 24 is above the reflective layer 22, and the metal wire 24 is electrically connected to the light emitting chip 23 with the interconnection layer 213 of the circuit board 21, the metal wire 24 do not occupy the area between the light emitting chip 23 and the reflective layer 22 so that the reflective layer 22 can extend to an edge of the light emitting chip 23 as near as possible. Therefore, a covering area of the reflective layer 22 can be maximized to raise the reflectivity of light emitted from the light emitting chip 23 and to improve the light emitting efficiency of the whole light emitting module. Referring to FIG. 3, a ratio of the area not covered by the reflective layer 22 to the area surrounded by the annular protruded structure 25 with deducting the area occupied by the light emitting chip 23 and ends of the metal wires 24, as an opening ratio, is less than or equal to 20%, preferred less than or equal to 10%.

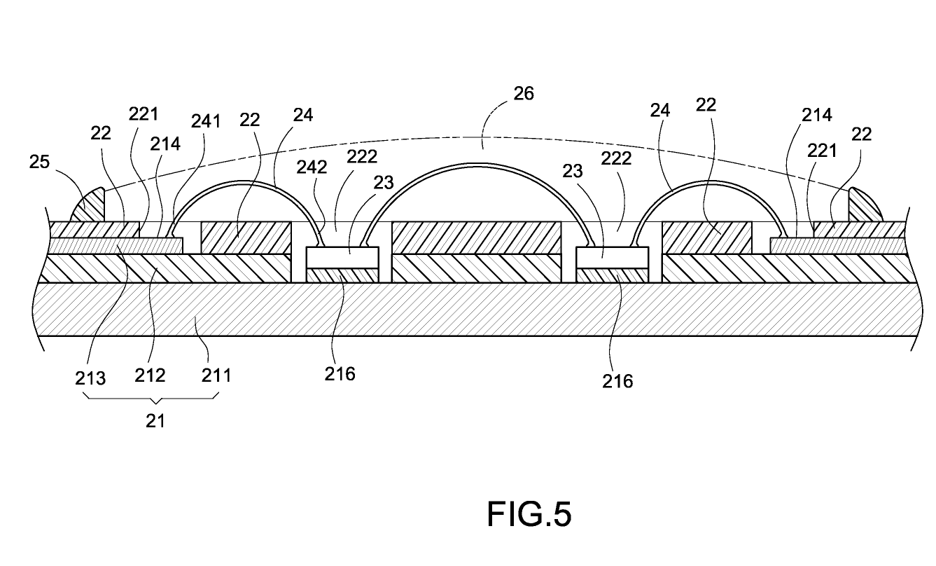

FIG. 5 is a schematic cross-sectional view showing a light emitting module of a second embodiment according to the present invention. As shown in FIG. 5, the structure of the light emitting module is similar to that of the first embodiment according to the present invention. The difference is that the embodiment shown in FIG. 5 further includes a heat dissipation layer 216 disposed between the circuit board 21 and the light emitting chip 23. Specifically, the heat dissipation layer 216 is disposed between the metal substrate 211 and the light emitting chip 23. The heat dissipation layer 216 is made of insulating material with excellent thermal conductive property. Accordingly, the light emitting chip 23 can be prevented from directly contacting to the metal substrate 211 so as to reduce the risk of the high voltage puncture to the light emitting chip 23. Alternatively, the heat dissipation layer 216 can be made of the same material to the interconnection layer 213 of the circuit board 21 so as to improve the heat dissipation effect and enhance the electro-optical conversion properties of the light emitting chip 23.

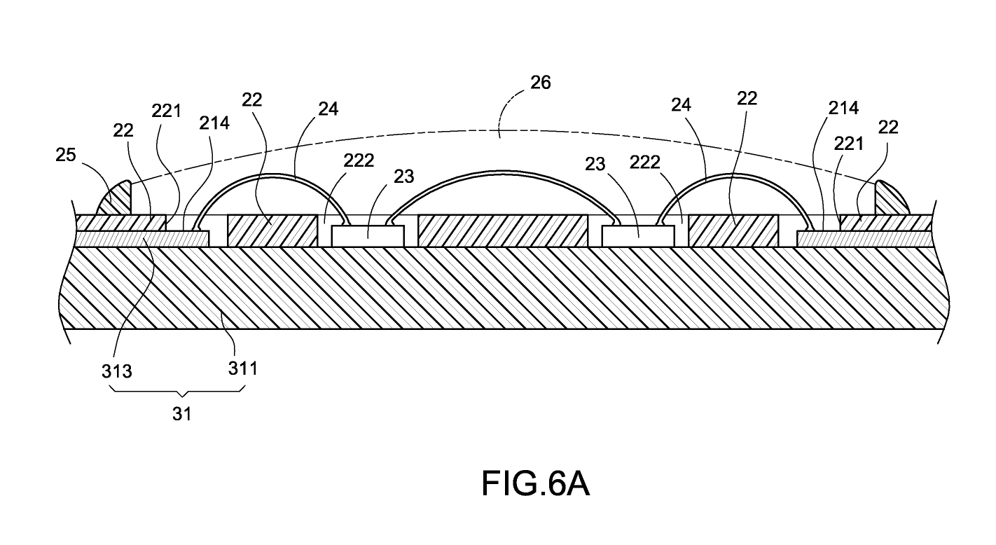

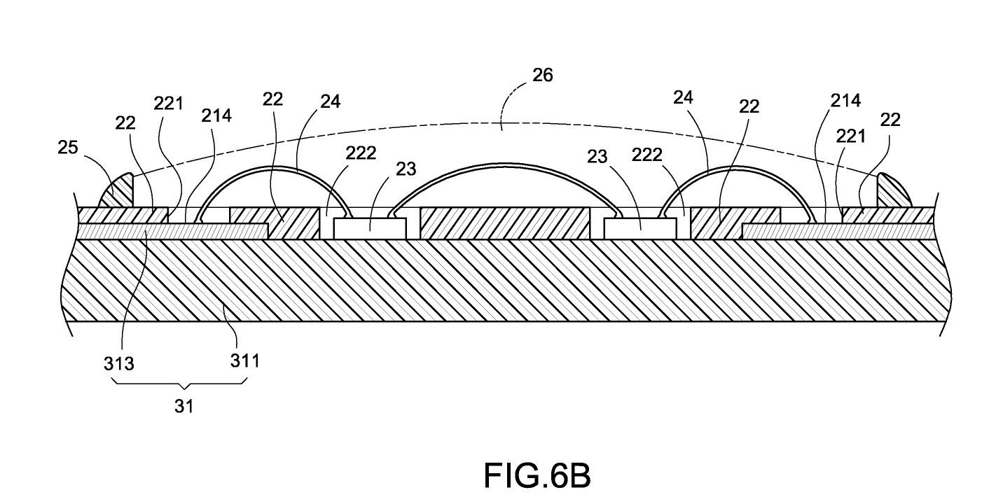

FIG. 6A is a schematic cross-sectional view showing a light emitting module of a third embodiment according to the present invention. As shown in FIG. 6A, the structure of the light emitting module is similar to that of the first embodiment according to the present invention. The difference is that the circuit board 31 includes a ceramic substrate 311 and an interconnection layer 313 disposed on the ceramic substrate 311, the interconnection layer 313 having a connecting pad 214. Since the ceramic substrate 311 has excellent thermal conductive property and insulating property, it also can reduce the risk of the high voltage puncture to the light emitting chip 23.

The embodiment shown in FIG. 6B is a variation of that shown in FIG. 6A. As shown in FIG. 6B, the structure of the light emitting module is similar to that of FIG. 6A. The difference is that the connecting pads 214 on the two sides respectively extend under the reflective layers 22 and cover all the exposed lower area of the first opening 221 in the embodiment. Accordingly, the ceramic substrate 311 having poor reflectivity can be covered as possible by the reflective layer 22 in order to improve the light emitting efficiency of the whole light emitting module.

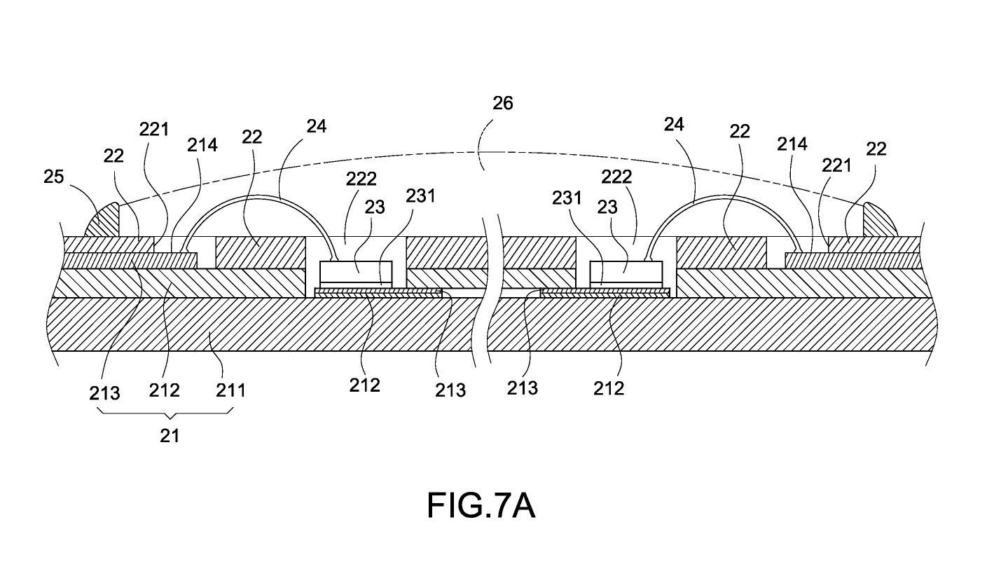

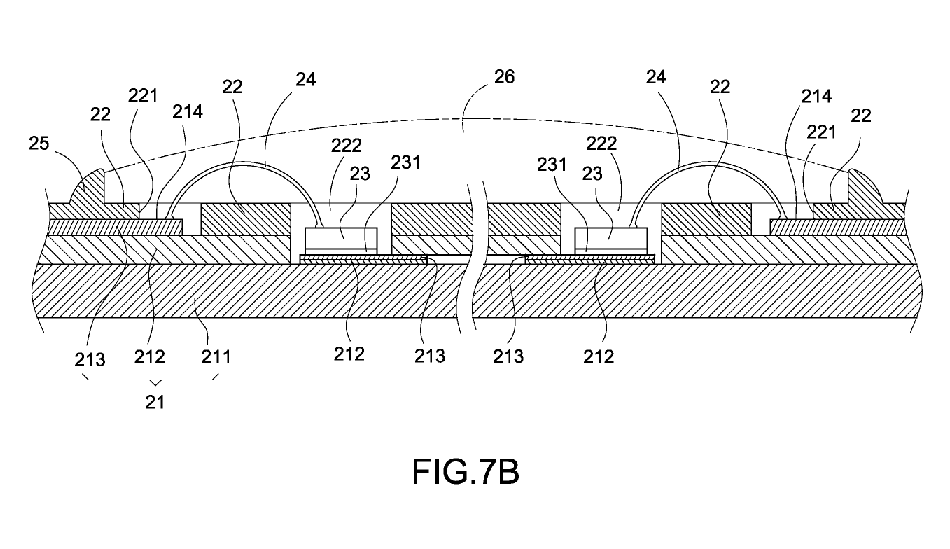

FIG. 7A is a schematic cross-sectional view showing a light emitting module of a fourth embodiment according to the present invention. As shown in the drawing, the structure of the light emitting module is generally similar to that of the first embodiment as shown in FIG. 2. The difference is that the light emitting chip 23 shown in FIG. 7A has two electrodes disposed on two opposite surfaces, the upper surface and the lower surface. The electrode on the upper surface of the light emitting chip 23 connected to the interconnection layer 213 is the same as that of the first embodiment by the metal wire 24. The electrode 231 on the lower surface of the light emitting chip 23 is directly connected to the interconnection layer 213 of the circuit board 21.

The embodiment shown in FIG. 7B is a variation of that shown in FIG. 7A. As shown in FIG. 7B, the structure of the light emitting module is similar to that of FIG. 7A. The difference is that the reflective layer 22 and the annular protruded structure 25 are formed integrally by using the same material. Therefore, the steps of the process and the cost can be reduced.

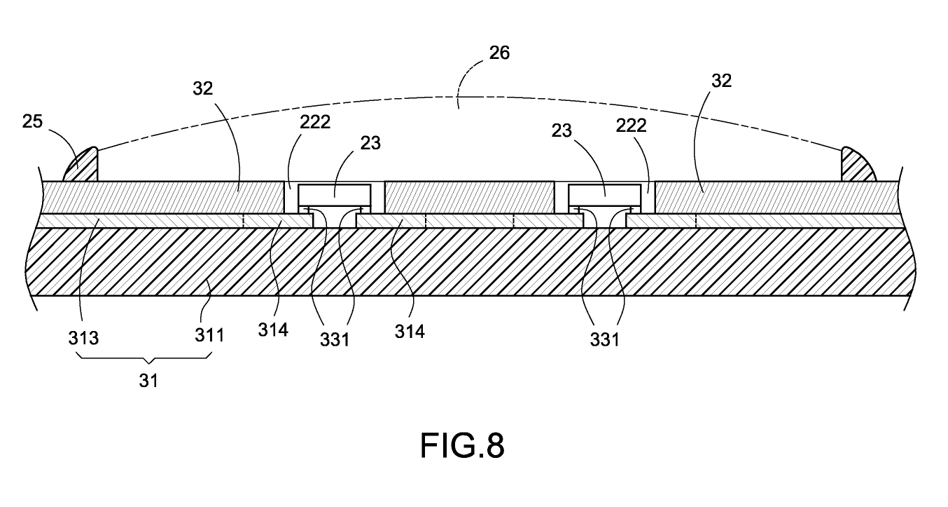

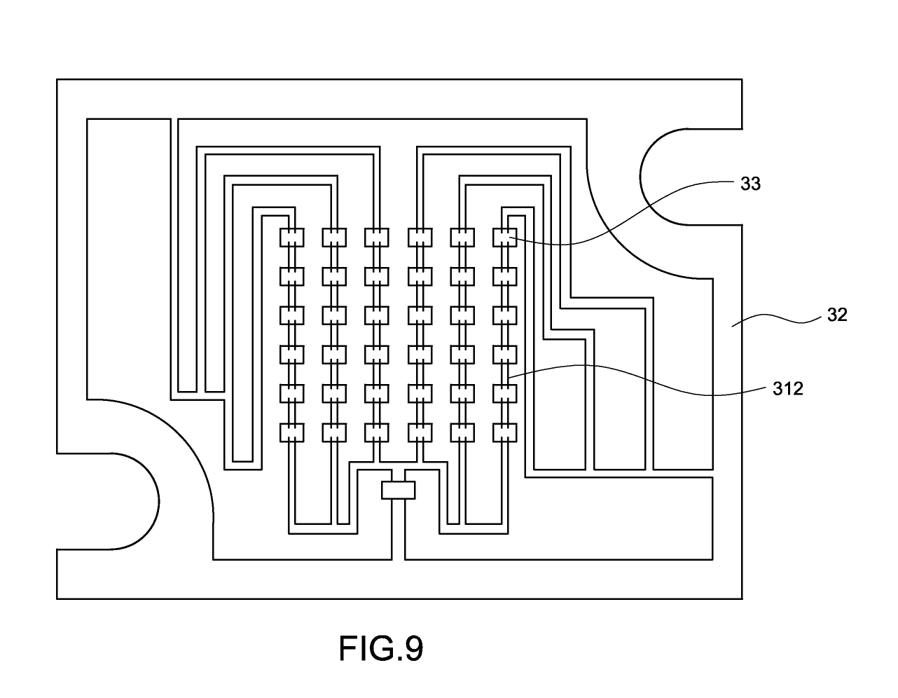

FIG. 8 is a schematic cross-sectional view showing a light emitting module of a fifth embodiment according to the present invention. As shown in the drawing, the structure of the light emitting module is generally similar to that of the first embodiment shown in FIG. 2. The difference is that the light emitting chip 23 shown in FIG. 8 has two electrodes 331 both disposed on the lower surface. Specifically, the circuit board 31 has two connecting pads 313. The reflective layer 32 is disposed on the circuit board 31, and has at least one first opening 222 so that the connecting pads 313 can be exposed therein. The light emitting chip 23 is disposed in the first opening 222, and has two electrodes 331 on the lower surface thereof. The electrodes 331 are directly connected to the connecting pads 313, respectively. FIG. 9 is a schematic top view of the fifth embodiment showing a plurality of light emitting chips 33 connected each other by the interconnection layer 312.

Accordingly, the connection of the light emitting chip 23 and the interconnection layer 313 can be simplified without wires. Therefore, the reflective layer 32 can be extended to an edge of the light emitting chip 23 as possible so that a covering area of the reflective layer 32 can be maximized to raise the reflectivity of light outputted from the light emitting chip 23 and to enhance the light emitting efficiency of the whole light emitting module.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A light emitting module, comprising:
a circuit board (21) having at least one connecting pad (214);
a reflective layer (22) disposed on the circuit board (21), the reflective layer (22) having at least one first opening (221) to expose the connecting pad (214) and having at least one second opening (222) to expose a portion of the circuit board (21);
at least one light emitting chip (23) disposed in the second opening (222); and
at least one metal wire (24) having a first end portion (241) connected to the connecting pad (214) in the first opening (221) and a second end portion (242) extending from the first end (241) and above the reflective layer (22), the second end portion (242) electrically connected to the light emitting chip (23) in the second opening (222).

2. The light emitting module of claim 1, wherein the circuit board (21) comprises a metal substrate (211), an insulating layer (212) disposed on the metal substrate (211) and an interconnection layer (213) disposed on the insulating layer (212), the interconnection layer (213) comprising the connecting pad (214).

3. The light emitting module of claim 1, wherein the circuit board (21) comprises a ceramic substrate (311) and an interconnection layer (213) disposed on the ceramic substrate (311), the interconnection layer (213) comprising the connecting pad (214).

4. The light emitting module of claim 1, further comprising a heat dissipation layer (216) disposed between the circuit board (21) and the light emitting chip (23).

5. The light emitting module of claim 1, wherein the second opening (222) has a shape in accordance with a shape of the light emitting chip (23).

6. The light emitting module of claim 1, including a plurality of light emitting chips (23) correspondent with a plurality of second openings (222) in number, the light emitting chips (23) being arranged in an array, and every two adjacent light emitting chips (23) being separated with a first predetermined distance (L1).

7. The light emitting module of claim 1, wherein the reflective layer (22) and each of the light emitting chips (23) are separated with a second predetermined distance (L2).

8. The light emitting module of claim 1, wherein the reflective layer (22) and the first end portion (241) of the metal wire (24) connecting to the connecting pad (214) are separated with a third predetermined distance (L3).

9. The light emitting module of claim 1, further comprising an annular protruded structure (25) disposed on the reflective layer (22) and around the first opening (221) and the second opening (222).

10. The light emitting module of claim 9, wherein the annular protruded structure (25) and the reflective layer (22) are formed integrally.

11. The light emitting module of claim 1, further comprising a wave length conversion layer disposed on the light emitting chip (23).

12. The light emitting module of claim 1, further comprising a protective layer (26) disposed on the light emitting chip (23).

13. A light emitting module, comprising:
a circuit board (31) having at least one connecting pad (313);
a reflective layer (32) disposed on the circuit board (31), the reflective layer (32) having at least one first opening (221) to expose the connecting pad (313); and
at least one light emitting chip (33) disposed in the first opening (221), and the light emitting chip (33) having at least one electrode (331) disposed on the lower surface thereof, the electrode (331) directly connecting to the connecting pad (313).

14. The light emitting module of claim 13, wherein the circuit board (31) comprises a metal substrate (211), an insulating layer (212) disposed on the metal substrate (211) and an interconnection layer (312) disposed on the insulating layer (212), the interconnection layer (312) comprising the connecting pad (313).

15. The light emitting module of claim 13, wherein the circuit board (31) comprises a ceramic substrate (311) and an interconnection layer (312) disposed on the ceramic substrate (311), the interconnection layer (312) comprising the connecting pad (313).

16. The light emitting module of claim 13, further comprising a heat dissipation layer (216) disposed between the circuit board (31) and the light emitting chip (33).

17. The light emitting module of claim 13, wherein the second opening (222) has a shape in accordance with a shape of the light emitting chip (33).

18. The light emitting module of claim 13, wherein the first opening (221) exposes the two connecting pads (313, 313), and the light emitting chip (33) has two electrodes (331, 331) on the lower surface thereof, the electrodes (331, 331) directly connecting with the connecting pads (313, 313), respectively.

19. The light emitting module of claim 13, including a plurality of light emitting chips (33) correspondent with a plurality of first openings (221) in number, the light emitting chips (33) being arranged in an array, and every two adjacent light emitting chips (33) being separated with a first predetermined distance (L1).

20. The light emitting module of claim 13, wherein the reflective layer (32) and each of the light emitting chips (33) are separated with a second predetermined distance (L2).

21. The light emitting module of claim 13, further comprising an annular protruded structure (25) disposed on the reflective layer (32) and around the first opening (221).
